(19) United States
(12) Patent Application Publication
(10) Pub. No.: US 2007/0198993 A1
(43) Pub. Date: Aug. 23, 2007

(54) Communication system event handling systems and techniques

(76) Inventors: Zhongyao Zhang, Kanata (CA); Fan Mo, Kanata (CA); Hamid Ismaili, Ottawa (CA); Lay-Been Tan, Kanata (CA)

Correspondence Address: Arnold B. Silverman;Eckert Seamans Cherin & Mellott, LLC, 44th Floor, 600 Grant Street, Pittsburgh, PA, 15219, US

(21) Appl. No.: 11/347,882

(22) Filed: Feb. 6, 2006

(51) Int. Cl. G06F 9/46

(52) U.S. Cl. 719/318

(57) ABSTRACT

Communication system event handling systems and techniques are disclosed. A generic event handling agent is provided, and controls transfer of event information between an interface to an event information processing system and a plurality of component modules. Each component module is operable to collect event information from a respective type of component in a communication system. The component modules may be implemented in software, and configurable to collect event information by using particular functional elements to perform respective tasks in a workflow process. Event handling techniques and architectures according to embodiments of the invention can provide a flexible and scalable system with substantially reduced software code duplication in comparison with conventional techniques.

### FIELD OF THE INVENTION

This invention relates generally to communications and, in particular, to event handling in communication systems.

### BACKGROUND

Alarm and other event supports on communication system components, such as routers, switches, and other network elements from various equipment vendors are typically implemented differently but yet provide similar basic functionalities. Without proper software design, code duplication and hence development effort can be enormous. Custom software code is normally required for handling events from each different type of component in a communication system. As the size and complexity of a communication system increases, event handling becomes a more complicated and resource intensive task.

Thus, there remains a need for improved event handling techniques.

### SUMMARY OF THE INVENTION

According to an aspect of the invention, there is provided an apparatus comprising an interface for allowing event information to be exchanged with an event processing system, the event processing system being operable to process event information associated with a communication system, and a component module manager operable to control transfer of event information between the interface and a plurality of component modules, each of the component modules being operable to collect event information from a respective type of component in the communication system.

The component modules may be implemented in software, in which case the component module manager may control transfer of event information by controlling loading of component module software for execution by a processing element.

In some embodiments, the loading comprises a dynamic loading process, the transfer of event information between the interface and a component module of the plurality of component modules being independent of the dynamic loading process for another component module of the plurality of component modules.

Where the apparatus also includes a memory for storing a component module list, the component module manager may be operable to control transfer of event information by enabling transfer of event information between the interface and each component module in the component module list.

The component module manager may be further operable to detect a component change in the communication system, and to control transfer of event information between the interface and a component module associated with a component affected by the component change.

The apparatus may also include an interface to a communication system database storing a record of components in the communication system, in which case the component module manager may be further operable to receive from the communication system database interface notifications of component changes in the communication system, and to detect the component change based on a received notification.

If the component change comprises addition of a new component to the communication system, the component module manager may enable transfer of event information associated with the new component between the interface and a component module operable to collect event information from the new component. If the component change comprises removal of an existing component from the communication system, the component module manager may disable transfer of event information associated with the existing component between the interface and a component module operable to collect event information from the existing component.

In some embodiments, the component module manager is operable to enable transfer of event information by identifying the component module operable to collect event information from the new component based on a multi-level identifier.

The component module manager may be operable to control transfer of event information between the interface and the component modules by managing sets of components from which the plurality of component modules respectively collect event information. The one or more sets of components may be managed by managing one or more lists of components respectively associated with the plurality of component modules.

The apparatus may be provided in an event handling system that also includes one or more component modules.

There is also provided an apparatus comprising an interface for allowing information to be exchanged with a type of communication system component, and a component monitor operatively coupled to the interface, the component monitor being configurable by an event handling agent to collect through the interface event information from a particular component of the component type in a communication system and to transfer the collected event information to an event processing system through the event handling agent.

At least one of the interface and the component monitor may be implemented in software for execution by a processing element.

In some embodiments, the component monitor is configurable to collect the event information by performing at least one of: polling the component through the interface, and listening for event information from the component through the interface.

The apparatus may also include an event agent registrator, the event agent registrator being operable to register the apparatus with the event handling agent.

If the apparatus comprises a memory for storing a list of components from which the component monitor is to collect event information, the component monitor is configurable to collect event information from a particular component by adding an identifier of the particular component to the list of components.

The component monitor may be configurable to establish one or more of: a time interval according to which event information is to be collected from the particular component, and a number of particular components from which the component monitor may collect event information.

In some embodiments, the component monitor is configurable to collect the event information by implementing a set of one or more functional elements in accordance with a workflow process, the functional elements having respective different tasks in the workflow process. At least one of the respective different tasks comprises a task associated with a plurality of workflow processes.

A system according to another aspect of the invention comprises an event handling agent for controlling exchange of event information with an event processing system, the event processing system being operable to process event information associated with a communication system, and a component module operatively coupled to the event handling agent and configurable by the event handling agent to collect event information from a particular component in the communication system and to transfer the collected event information to the event processing system through the event handling agent.

At least one of the event handling agent and the component module is implemented in software.

The event handling agent may be operable to control exchange of event information between the event processing system and a plurality of component modules including the component module, each of the component modules being operable to collect event information from a respective type of communication system component and configurable by the event handling agent to collect event information from one or more particular components of its respective type in a communication system.

The event handling agent may configure a component module to collect event information from one or more components of its respective type by adding an identifier of each of the one or more components to a component list used by the component module to determine any components from which event information is to be collected.

The event handling agent may be further operable to detect a component change in the communication system, to configure a component module of the plurality of component modules to collect event information from a new component where the component change comprises addition of the new component to the communication system, and to configure a component module of the plurality of component modules to stop collecting event information from an existing component where the component change comprises removal of the existing component from the communication system.

In some embodiments, the component module comprises one or more component monitors for collecting event information from components in the communication system, the component module being configurable to provide a particular number of the component monitors.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of a communication system.

FIG. 2 is a block diagram of an event surveillance system.

FIG. 3 is a block diagram of an event handling agent.

FIG. 4 is a block diagram of a component module.

FIG. 5 is a flow diagram of an event handling method.

FIG. 6 is a block diagram of a data structure.

### DETAILED DESCRIPTION OF PREFERRED EMBODIMENTS

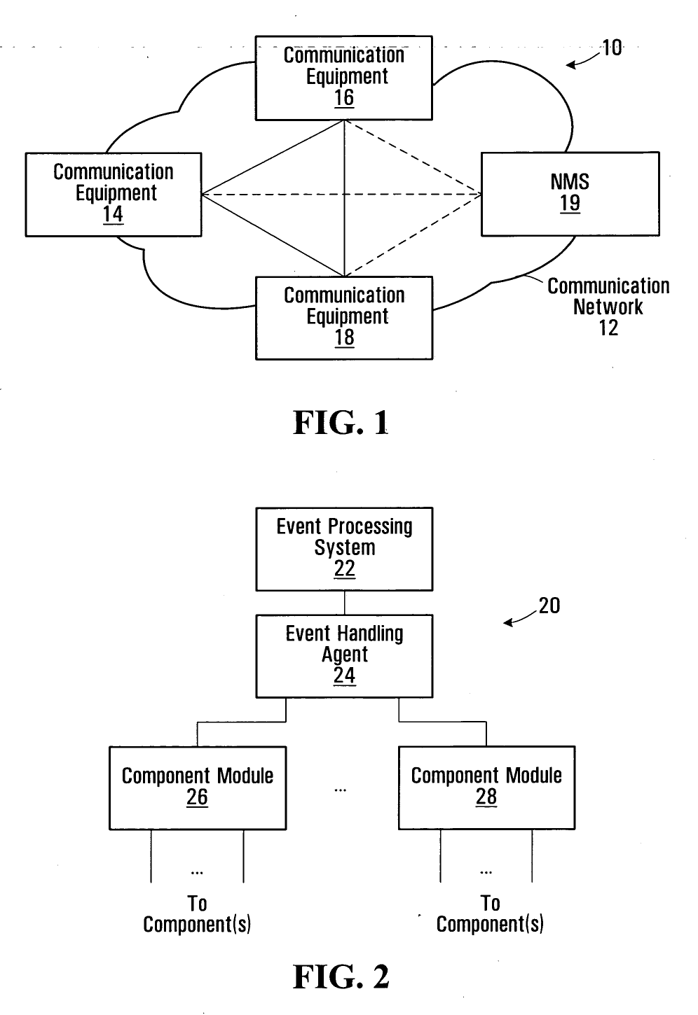

FIG. 1 is a block diagram of a communication system 10. The communication system 10 includes a communication network 12, communication equipment 14, 16, 18, and a Network Management System (NMS) 19.

Although a communication system may include multiple communication networks, each having respective communication equipment and possibly an NMS, only one communication network 12 and one NMS 19 have been shown in FIG. 1 to avoid overly complicating the drawing. A communication network may also have more or fewer than three installations of communication equipment 14, 16, 18. In addition, other equipment may be provided within a communication network or operate in conjunction with a communication network, such as end user equipment and other user, management, or control equipment.

It should therefore be appreciated that the communication system 10 of FIG. 1, as well as the contents of the other drawings, are intended solely for illustrative purposes, and that the present invention is in no way limited to the particular example embodiments explicitly shown in the drawings and described herein.

The communication network 12 includes equipment 14, 16, 18 through which communications may be established. The equipment 14, 16, 18 in the communication network 12 may be operatively coupled together through any of various types of connections over which communication signals can be exchanged. Connections may include wired connections, wireless connections, or some combination thereof. Communications over these connections may be established, for example, for telephone calls and data communication sessions.

The particular types of connections and communication signal exchange available in the communication network 12 are at least to some extent dependent upon the equipment 14, 16, 18 used to implement the network, the protocols used in the network, the services offered by service providers using the network, the end user equipment for which the connections are established, for instance, and/or possibly other factors.

The communication equipment 14, 16, 18, may include network elements such as switches or routers, or other types of communication equipment. Those skilled in the art will be familiar with these and many other examples of communication equipment.

Control and management functions, which may include connection setup, management, and release, failure protection, network monitoring, and event surveillance and processing, for example, are provided by the NMS 19. The NMS 19 is operatively coupled to the equipment 14, 16, 18 and exchanges at least control information with these components. Control paths between the NMS 19 and the equipment 14, 16, 18 may share the same network connections as data paths between the equipment 14, 16, 18, although separate, dedicated control connections may also or instead be used. An illustrative example of an apparatus that may be provided in an NMS 19 is shown in FIGS. 2-4 and described below.

The operation of many different types of communication system will be apparent to those skilled in the art. As the present invention relates primarily to event handling functions provided at the NMS 19, actual communication functions in a communication system are described in detail herein only to the extent necessary to illustrate features of embodiments of the invention.

The NMS 19 may provide a management tool through which an operator or other personnel can perform various management functions for the communication system 10. A management tool is often implemented in software that allows an operator to view and manipulate management and configuration information. Such a tool might display operating conditions, performance metrics, error/fault information, indications of whether certain conditions have been observed, etc. Information to be brought to the attention of an operator and/or an element of a management or monitoring system is generally referred to herein as event information.

According to one particular embodiment of the invention, the concept of an event handling agent is introduced. The event handling agent simplifies event support with more effective software design, applying “plug and play” type concepts to provide a generic event agent. In some embodiments, an event handling agent performs basic event handling functions such as event registration, event registration protection to repeat a registration process with a system or device that periodically deletes registrations, synchronization, polling, and/or forwarding, possibly among other functions. Component modules that collect event information from specific types of communication system components, such as one or more NMSs or different types of communication equipment, may utilize and inherit all, or a subset, of the basic functionalities of the event handling agent.

FIG. 2 is a block diagram of an event surveillance system according to an embodiment of the invention. The system 20 includes an event processing system 22, an event handling agent 24 operatively coupled to the event processing system 22, and component modules 26, 28 operatively coupled to the event handling agent 24.

A system or device incorporating the apparatus 20 may include additional elements, such as elements that provide other communication system management functions than event handling and processing, for example. The apparatus 20 may also or instead incorporate further elements that support event-related functions, illustratively one or more other event handling agents that provide event information to the event processing system 22, but might not necessarily support component modules in the manner disclosed herein. The event handling agent 24 may thus co-exist with other event handling agents or elements.

It should also be appreciated that the specific division of functions represented by the elements 22, 24, 26, 28 is intended solely for the purposes of illustration and not to limit the scope of the invention. Other embodiments of the invention may include further, fewer, or additional elements interconnected in a similar or different manner.

The elements of the system 20 may be operatively coupled to each other through physical connections or through logical interconnections where any of the elements are implemented using software for execution by one or more processing elements. In one implementation, the event handling agent 24 and the component modules 26, 28 are related in a software class structure in which functions may be shared or inherited between classes, and may thus be considered to be coupled to each other through logical connections or associations.

From the foregoing, it will be apparent that many of the elements of the system 20 may be implemented using hardware, software, firmware, or any combination thereof. Those skilled in the art will be familiar with many devices that may be used in implementing the system 20, including microprocessors, microcontrollers, Application Specific Integrated Circuits (ASICs), Programmable Logic Devices (PLDs), and/or Field Programmable Gate Arrays (FPGAs), for example.

In view of the many possible implementations of the elements shown in FIG. 2, these elements are described herein primarily in terms of their functions. Based on these functional descriptions, a skilled person would be enabled to implement embodiments of the invention in any of various ways.

The event processing system 22 may perform such functions as maintaining a record of events requiring some further action, illustratively active or unresolved alarms, generating displayed and/or other types of event notifications, forwarding event information to one or more event feed clients, etc. Such event processing functions may be supported by an NMS or other management system, for example.

Embodiments of the invention relate primarily to the event handling agent 24 and the component modules 26, 28. The event handling agent 24 is effectively a generic interface to the event processing system 22 for the component modules 26, 28, which collect event information from different types of components in a communication system. These components may include communication equipment and/or other systems or devices associated with a communication system.

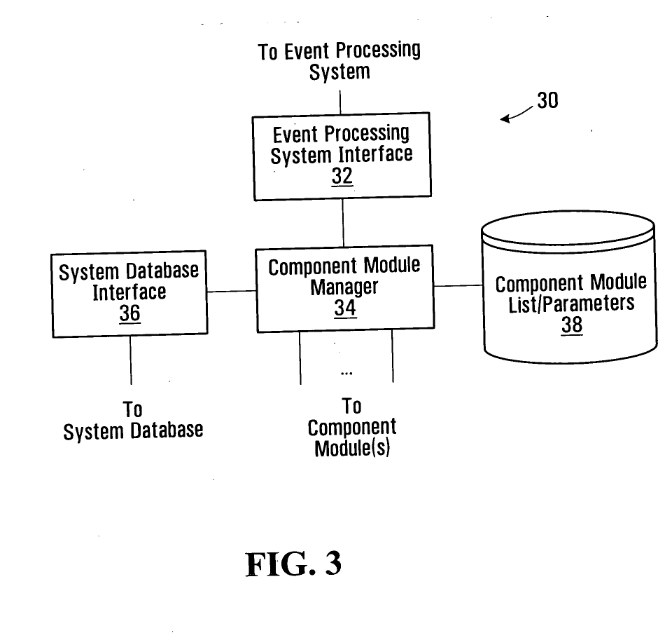

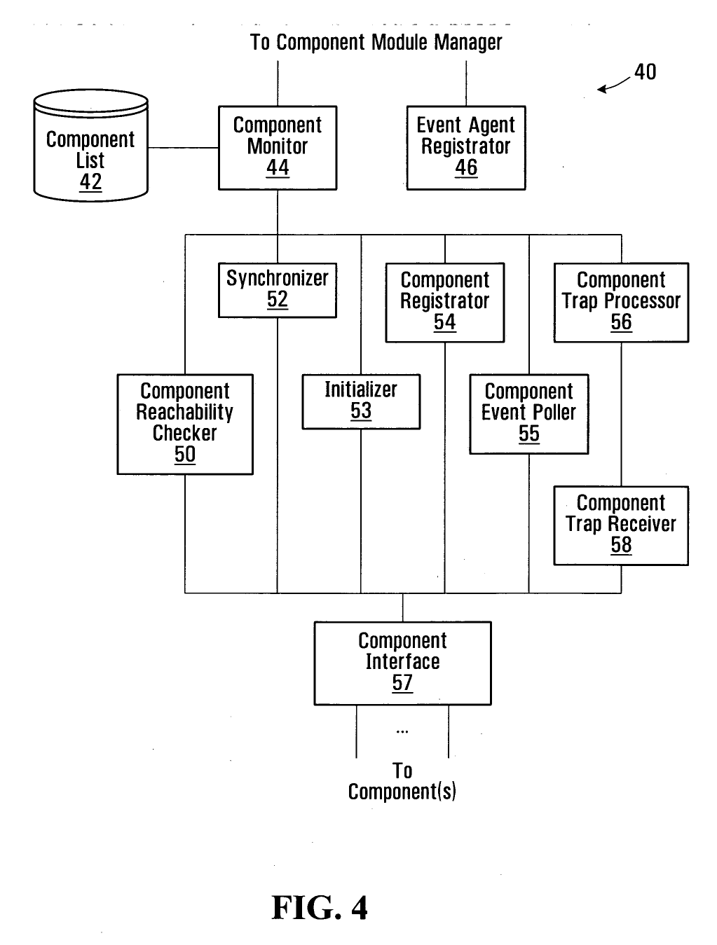

Instead of requiring custom end-to-end event support between the event processing system 22 and each monitored component in a communication system, which as noted above can lead to increased development efforts and code duplication, the event handling agent 24 can provide generic functions that may be used by any or all of the component modules 26, 28 and thus need not be separately implemented by every component module. Examples of an event handling agent and a component module are described in detail below with reference to FIGS. 3 and 4, respectively.

FIG. 3 is a block diagram of an event handling agent. As shown, the event handling agent 30 includes an event processing system interface 32, a component module manager 34 operatively coupled to the event processing system interface 32, a system database interface 36 operatively coupled to the component module manager 34, and a data store 38 for storing a component module list and/or parameters.

Like the elements shown in FIG. 2, the elements of FIG. 3 may be implemented in software, hardware, firmware, or some combination thereof. Interconnections between those elements may thus include physical and/or logical connections. The data store 38, however, would generally be provided as a storage area in a hardware component, specifically one or more memory devices. Solid state memory devices are common in communication equipment, although a system in which the agent 30 is implemented may also or instead include memory devices for use with movable or even removable memory media.

The event processing system interface 32 allows event information to be exchanged with an event processing system, such as the event processing system 22 (FIG. 2), which is operable to process event information associated with a communication system. In terms of implementation, the interface 32 need not necessarily be a physical hardware interface. Application Programming Interfaces (APIs) and protocol interfaces represent examples of logical or software interfaces that may be used to provide the interface 32. An element may send information on a logical interface by calling a certain function or routine associated with that interface, for example. References to interfaces in the present application should be interpreted accordingly.

As described in further detail below, other information than event information may be of use to the event handling agent 30. The system database interface 36 provides an interface through which the event handling agent 30 may obtain communication system information, such as the particular components deployed in a communication system.

The component module manager 34 is operable to control transfer of event information between the interface 32 and multiple type-specific component modules. The component modules collect event information from respective types of components in a communication system, and may also exchange other information and perform other functions with those components. At any time, there may be multiple component modules, one component module, or no component modules actually installed or loaded at a management system. However, the component module manager 34 has the capability to manage multiple component modules, if and when such modules are installed.

The component modules managed by the component module manager 34 may be implemented in software, for example. In this case, the component module manager 34 may control transfer of event information between the interface 32 and the component modules by controlling a software loading operation. The component module manager 34 might load software for only those component modules that interact with components that are actually deployed in a communication system, for instance.

According to one embodiment, the component module manager 34 determines which component modules are to be loaded based on a list of component modules stored in the data store 38. The data store 38 might include a list of components to be loaded by the component module 34 during initialization of the agent 30. A list of all available component modules, which may include available but not currently required component modules, and the corresponding component types from which they can collect event information may also or instead be stored in the data store 38. Component module configuration information, labelled in FIG. 3 as parameters, may also be stored in the data store 38 and retrieved by the component module manager 34 to configure such operating characteristics as event polling interval and performance metric collection for any or all component modules.

As described in further detail below, available component modules that have been loaded may automatically register themselves or otherwise be registered with the component module manager 34.

Component module loading may be a dynamic process controlled by the component module manager 34. In some embodiments, after a new component module has been installed in the system by storing configuration files and executable code in a memory for instance, an instruction or command can be sent to the component module manager 34 to cause the component module manager to load the new component module. The new component module then registers itself with the component module manager 34. This provides for “hot” upgrade or deployment of new component without interrupting the operation of the entire event handling agent 30. Component module loading and event information transfer can thus be substantially independent.

An identifier, and possibly a component type and/or parameters for a registered component module, are added to the data store 38 when the component module is registered with the component module manager 34. Registration requirements may be applied by the component module manager 34 before component module registration is accepted or completed. For example, registration of a component module might be rejected or aborted by the component module manager 34 if the component module does not include certain types of information such as a reference to a configuration file containing its configuration information or if its configuration file is empty. Other exception handling procedures may be provided to address these or other requirements or unexpected conditions.

Another possible use of information stored in the data store 38 is ongoing control of component modules responsive to changes in a managed communication system. As noted above, the component module manager 34 may obtain communication system information through the system database interface 36. This may involve registering the component module manager 34 with a database change notification process (not shown) of an NMS, for example. In this case, the component module manager 34 is notified when changes are made in the communication system and the system database. However, other change monitoring techniques may also or instead be used.

Once a component change is detected, the component module manager 34 may take action to control the specific alarm information that is subsequently transferred to and/or from the interface 32. Suppose, for example, that a detected component change is the addition of a new component to the communication system. The component module manager 34 may then enable transfer of alarm information associated with the new component between the interface 32 and a component module that is operable to collect event information from the new component.

In one embodiment, the component module manager 34 determines the type of the new component from information received through the system database interface 36. The corresponding component module for that component type may then be determined by referring to a component module list in the data store 38. The component type or types with which a component module is capable of interacting may be stored in the data store 38 as a mapping table for instance, although other ways of mapping component modules to their corresponding component types may instead be used.

When the component module manager 34 has identified the appropriate component module for the new component, the new component is assigned to that component module. If it has not already been loaded, the component module can be loaded by the component module manager 34. An operator might install a new component module for a new type of component that has been added to a communication system and then, as described above, instruct the component module manager 34 to load the new component module, for example.

The function of assigning a component to a component module may involve writing an identifier of the component in a component list used by the component module to determine the particular component or set of components in a communication system from which it is to collect event information. A new component identifier may be added to the component list of a component module directly by the component module manager 34 or by the component module, responsive to a command or instruction from the component module manager for instance. Other information such as an address or other contact information may also be provided to a component module.

Removal of a component from the communication system can be detected in a similar way. For a component removal, however, a component module would be configured by the component module manager 34 to stop collecting event information from a removed component. Otherwise, the component module might continue to attempt to communicate with the removed component. Where component modules maintain component lists, the component module manager may delete, or instruct the component module to delete, the identifier and any other information associated with a removed component.

FIG. 4 is a block diagram of an example component module. Although the component module 40 is a relatively detailed example, it should be appreciated that a component module may include fewer or different elements than those explicitly shown, or in some embodiments additional elements. As described below, for example, the component monitor 44 could be configurable to compose different elements according to the characteristics of different components to be monitored.

The component module 40 includes a data store 42 storing a component list, a component monitor 44 operatively coupled to the data store 42, an event agent registrator 46, and various elements operatively coupled to the component monitor 44. These elements include a component reachability checker 50, a synchronizer 52, an initializer 53, a component registrator 54, a component event poller 55, a component trap processor 56, and a component trap receiver 58, and are also operatively coupled to a component interface 57, which allows the component module 40 to exchange information with one or more communication system components.

As described above with reference to FIGS. 2 and 3, many of the elements shown in FIG. 4 may be implemented in software, hardware, firmware, or some combination thereof, and accordingly the following description of such elements in terms of function will fully enable a person skilled in the art to implement embodiments of the invention in any of various ways. In many implementations, however, the data store 42 would be provided as a memory area in a memory device.

According to one embodiment, the elements 50, 52, 53, 54, 55, 56, 58 are implemented at least partially in software, illustratively as SNMP (Simple Network Management Protocol) worker processes, although these elements may use other common communication protocols such as Q3 or TL1. Each SNMP worker is a thread, and can perform SNMP processes on a monitored component. These workers may inherit from an SNMP worker parent class, and can also be inherited to provide an extendable component module software architecture. The component monitor 44 itself can similarly be extended by sub-classing.

The component monitor 44 is the central controller of the component module 40. Its responsibilities may include selection of a particular collection of functional elements for the component module 40 according to the configuration file, and workflow control.

The workflow of event information handling may be partitioned/pipelined and delegated to different functional elements. Each element is only responsible for a specific task assigned by the component monitor 44, and to provide updated state information. The component monitor 44 watches the state information for each monitored component and makes a decision as to the next task to be performed for that component. The next task is then assigned to the corresponding element. The same tasks and functional elements are re-usable by component monitors in different workflow processes. Basic alarm information-related functions are thereby encapsulated into a set of re-usable functional elements.

In one embodiment, a default workflow is implemented in the component monitor 44. The component monitor 44 can also be extended to implement a customized workflow control scheme.

The component monitor 44 is configurable by an event handling agent to collect event information from one or more particular components through the interface 57 and to transfer the collected event information to an event processing system through the event handling agent. This process may also involve other elements of the component module 40, as described below.

In general, a component module will collect event information from a certain type of communication system component. Communication system component type in the context of the present application is primarily related to event generation and transfer schemes, which tend to vary between components having different manufacturers and/or different communication functions. It should therefore be appreciated that different component types may be components from different manufacturers, components that perform different communication functions, or more generally components that for some reason have varying event functionality.

Although shown in FIG. 4 as a single block, a component module may include multiple component monitors 44, to provide load balancing for instance. In a software-based implementation, for example, an instance of a component monitor may be created when event monitoring load reaches a predetermined level. Some embodiments may allow an operator to specify an initial number of component monitors for a component module before the component module is loaded by an alarm handling agent.

Multiple component monitors may also enhance the scalability of a component module, in that a component module can scale well as the number of components to be monitored increases. A new threading model provided by SNMP, for example, may be used to allow a higher degree of task concurrency to be implemented in a component module, thereby improving performance and scalability.

Identifiers of the component(s) from which the component module 40 is to collect event information are stored in the component list data store 42. An event handling agent may thus configure the component module 40 to collect event information from a component or set of components by causing component identifiers to be written to or deleted from the component list. In the example component module 40, the component monitor 44 performs write and erase operations for the data store 42, although in other embodiments, an event handling agent may access a component list data store directly.

Considering now the other functional elements shown in FIG. 4 in more detail, registration of the component module 40 with an event handling agent, or in some embodiments a component module manager of such an agent, is performed by the event agent registrator 46. A component module identifier and other information associated with the component module 40 is provided to the event handling agent by the registrator 46. A configuration file including parameters for the component module 40 may also be provided to the event handling agent during the registration process or separately.

The component reachability checker 50 tests communications with a monitored component, and preferably each monitored component. In order to ensure that the component module 40 can actually communicate with a component, the checker 50 might periodically send a “ping” or other test message to the component and generate an error message or other alert in the event that a response is not received from the component within a specific time period. Such an error message or alert might be included in event information transferred to the event handling module by the component module 44, and/or used for some other purpose, such as to trigger the initializer 53 to re-initialize the component module 40 or to trigger the component registrator 54 to re-register the component module 40 with the component.

The synchronizer 52 obtains event information, such as current active alarms, for monitored components. In one embodiment, the synchronizer 52 obtains this information from a monitored component when the component is first added to a communication system or when communications with the component have been re-established after an interruption. The synchronizer 52 may also or instead obtain event information from each monitored component when the component module 40 is first started or re-started, or a synchronization request is received from the component module manager. Such a request may be generated in response to a user input or detection of an out-of-sync condition between the component module 40 and one or more of its monitored components.

Initialization operations between the component module 40 and its monitored component(s) are handled by the initializer 53. The nature of these operations may vary between different components and/or component types.

Event monitoring for some components or component types may require that event clients register with a component in order to receive event notifications. Operations involved in registering the component module 40 with its monitored component(s) are performed by the component registrator 54. The component registrator 54 may perform multiple tasks to complete a component registration process, or repeat a registration process where an initial component registration process fails or a component deletes registrations periodically, for example.

The component event poller 55 polls the component to obtain event information, illustratively alarm information from the component's alarm table. A poll interval may be specified in the configuration file for the component module 40, or the component module 40 may be configured by an event handling agent with a default interval or other interval.

The event poller 55 and synchronizer 52 may obtain similar event information or different event information. In one embodiment, the synchronizer 52 initially obtains event information at startup or when a component is first added to a communication system, and the event poller 55 then takes over the event information collection function and periodically polls the component. According to other embodiments, the poller 55 and synchronizer 52 have different target objects to track on monitored components. For example, the synchronizer 52 might collect event information from an active alarm table that is stored at a monitored component in a separate memory location from an alarm logging table polled by the poller 55. The elements 52, 55 may also be used at different phases of an event handling workflow.

A component module may also or instead receive event information from a component without having first transmitted a polling message or other request to the component. Event information collection may thus include the more passive operation of listening for event information.

Traps are often used in communication systems to collect information relating to events. In the component module 40, the trap receiver 58 may establish a trap session with a trap filter (not shown) so that it receives traps from its monitored components. A trap filter may use a list of component identifiers, such as Internet Protocol (IP) addresses, to implement a filtering function.

The trap receiver 58 passes any received traps to the trap processor 56, which processes the traps to convert the traps into a format for transfer to the event handling agent, for example. Separate implementation of the trap receiver 58 and the trap processor 56 may be preferred in that the trap receiver 58 could be common to multiple component types, with just the trap processor 56 being adapted to particular component types. This facilitates the implementation of customized processing traps.

Event information format conversion and other processing of type-specific event information may be performed by the component monitor 44 or by another element of the component module 40, such as the trap processor 56.

For the actual transfer of event information, and possibly other information, between the component module 40 and an event handling agent, the component monitor 44 and the event agent registrator 46 may be adapted for a particular transfer protocol. To aid in the development of component modules, a vendor of an event handling agent for a particular NMS might publish interface/protocol specifications. Component module developers are then able to adapt component modules to operate with the event handling agent.

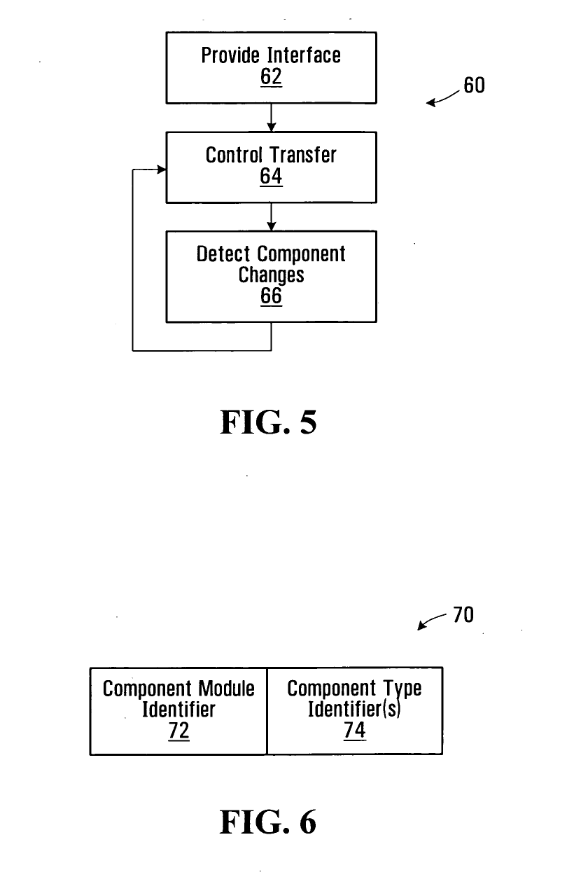

FIG. 5 is a flow diagram of an event handling method. The method 60 includes an operation 62 of providing an interface to an event processing system, and operations 64, 66 that may be performed by an event handling agent. As described in detail above, an event handling agent controls the transfer of event information between an event processing system interface and component modules, as shown at 64. In some embodiments, this control is adapted for component changes, detected at 66.

The operations at 62, 64, 66 may be performed in any of various ways, some of which may be apparent from the foregoing description of FIGS. 1-4. It should also be appreciated that other embodiments of the invention may include further, fewer, or different operations, performed in a similar or different order than explicitly shown.

FIG. 6 is a block diagram of a data structure. The data structure 70 includes an identifier 72 of a component module and one or more identifiers 74 associated with the type of component from which the component module can collect event information.

As described above, component type in the context of component modules relates to event information function support at particular components. Different components, such as routers from two different manufacturers, may provide similar event information function support, and thus may be associated with the same component type and module. The data field 74 may thus include one or more different identifiers for associating components with component modules.

Multi-level identifiers are also contemplated. For example, a component type and a subtype may be stored at 74, with a particular component being assigned to a component module if both its component type and subtype match the component type and subtype of the component module. This could be useful where an operator wishes to define a “custom” component representation to be used for components that might not be recognized by a particular management system. The use of a subtype in addition to a component type would allow different components represented by the same custom component representation and component type to be differentiated and associated with different component modules by using different subtypes. Multi-level identifiers would similarly allow different versions of the same component to be differentiated for the purposes of component module assignment.

In one embodiment, a data record having a format as shown in FIG. 6 is stored on a machine-readable medium in a component module list to be used by a component module manager in identifying the appropriate component module for a component in a communication network.

A data structure associated with a component module may also or instead include configuration information. As described above, each component module and its runtime instance, the component monitor, can be configured to employ different types of functional elements or workers at runtime. The specific elements or workers that are selected and used by a component monitor may be controlled by stored configuration information.

Embodiments of the present invention as disclosed herein can provide significant advantages such as reduced development effort, enhanced code modularity and re-usability, and the elimination of code duplication for generic event handling functions.

What has been described is merely illustrative of the application of principles of embodiments of the invention. Other arrangements and methods can be implemented by those skilled in the art without departing from the scope of the present invention.

For example, the specific division of functions shown in the drawings are intended solely for the purpose of illustration. Embodiments of the invention may be implemented using further, fewer, or different functional elements interconnected in a similar or different way than explicitly shown.

It should also be appreciated that the various elements and components disclosed herein may exchange other types of information than event information. An event handling agent transfers component identifiers to component modules, for instance.

In addition, although described primarily in the context of methods and systems, other implementations of embodiments of the invention are also contemplated, such as in instructions or data structures stored on machine-readable media.

We claim:

1. An apparatus comprising:
an interface for allowing event information to be exchanged with an event processing system, the event processing system being operable to process event information associated with a communication system; and
a component module manager operable to control transfer of event information between the interface and a plurality of component modules, each of the component modules being operable to collect event information from a respective type of component in the communication system.

2. The apparatus of claim 1, wherein the component modules are implemented in software, and wherein the component module manager is operable to control transfer of event information by controlling loading of component module software for execution by a processing element.

3. The apparatus of claim 2, wherein the loading comprises a dynamic loading process, the transfer of event information between the interface and a component module of the plurality of component modules being independent of the dynamic loading process for another component module of the plurality of component modules.

4. The apparatus of claim 1, further comprising:
a memory for storing a component module list,
wherein the component module manager is operable to control transfer of event information by enabling transfer of event information between the interface and each component module in the component module list.

5. The apparatus of claim 1, wherein the component module manager is further operable to detect a component change in the communication system, and to control transfer of event information between the interface and a component module associated with a component affected by the component change.

6. The apparatus of claim 5, further comprising:
an interface to a communication system database storing a record of components in the communication system,
wherein the component module manager is further operable to receive from the communication system database interface notifications of component changes in the communication system, and to detect the component change based on a received notification.

7. The apparatus of claim 5, wherein the component module manager is operable, where the component change comprises addition of a new component to the communication system, to enable transfer of event information associated with the new component between the interface and a component module operable to collect event information from the new component, and is further operable, where the component change comprises removal of an existing component from the communication system, to disable transfer of event information associated with the existing component between the interface and a component module operable to collect event information from the existing component.

8. The apparatus of claim 7, wherein the component module manager is operable to enable transfer of event information by identifying the component module operable to collect event information from the new component based on a multi-level identifier.

9. The apparatus of claim 1, wherein the component module manager is operable to control transfer of event information between the interface and the component modules by managing sets of components from which the plurality of component modules respectively collect event information.

10. The apparatus of claim 9, wherein the component module manager manages the one or more sets of components by managing one or more lists of components respectively associated with the plurality of component modules.

11. An event handling system comprising:
the apparatus of claim 1; and
one or more component modules.

12. An apparatus comprising:
an interface for allowing information to be exchanged with a type of communication system component; and
a component monitor operatively coupled to the interface, the component monitor being configurable by an event handling agent to collect through the interface event information from a particular component of the component type in a communication system and to transfer the collected event information to an event processing system through the event handling agent.

13. The apparatus of claim 12, wherein at least one of the interface and the component monitor is implemented in software for execution by a processing element.

14. The apparatus of claim 12, wherein the component monitor is configurable to collect the event information by performing at least one of: polling the component through the interface, and listening for event information from the component through the interface.

15. The apparatus of claim 12, further comprising:
an event agent registrator, the event agent registrator being operable to register the apparatus with the event handling agent.

16. The apparatus of claim 12, further comprising:
a memory for storing a list of components from which the component monitor is to collect event information,
wherein the component monitor is configurable to collect event information from a particular component by adding an identifier of the particular component to the list of components.

17. The apparatus of claim 12, wherein the component monitor is configurable to establish one or more of: a time interval according to which event information is to be collected from the particular component, and a number of particular components from which the component monitor may collect event information.

18. The apparatus of claim 12, wherein the component monitor is configurable to collect the event information by implementing a set of one or more functional elements in accordance with a workflow process, the functional elements having respective different tasks in the workflow process.

19. The apparatus of claim 18, wherein at least one task of the respective different tasks comprises a task associated with a plurality of workflow processes.

20. A system comprising:
an event handling agent for controlling exchange of event information with an event processing system, the event processing system being operable to process event information associated with a communication system; and
a component module operatively coupled to the event handling agent and configurable by the event handling agent to collect event information from a particular component in the communication system and to transfer the collected event information to the event processing system through the event handling agent.

21. The system of claim 20, wherein at least one of the event handling agent and the component module is implemented in software.

22. The system of claim 20, wherein the event handling agent is operable to control exchange of event information between the event processing system and a plurality of component modules including the component module, each of the component modules being operable to collect event information from a respective type of communication system component and configurable by the event handling agent to collect event information from one or more particular components of its respective type in a communication system.

23. The system of claim 22, wherein the event handling agent configures a component module to collect event information from one or more components of its respective type by adding an identifier of each of the one or more components to a component list used by the component module to determine any components from which event information is to be collected.

24. The system of claim 22, wherein the event handling agent is further operable to detect a component change in the communication system, to configure a component module of the plurality of component modules to collect event information from a new component where the component change comprises addition of the new component to the communication system, and to configure a component module of the plurality of component modules to stop collecting event information from an existing component where the component change comprises removal of the existing component from the communication system.

25. The system of claim 22, wherein the component module comprises one or more component monitors for collecting event information from components in the communication system, the component module being configurable to provide a particular number of the component monitors.
